(19) United States
(12) Patent Application Publication
(10) Pub. No.: US 2009/0189848 A1
(43) Pub. Date: Jul. 30, 2009

(54) METHOD OF DRIVING ELECTROPHORETIC DISPLAY DEVICE, ELECTROPHOTETIC DISPLAY DEVICE, AND ELECTRONIC APPARATUS

(75) Inventor: Hiroshi MAEDA, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/276,597

(22) Filed: Nov. 24, 2008

(30) Foreign Application Priority Data
Jan. 24, 2008 (JP) 2008-013634

(51) Int. Cl. G09G 3/34

(52) U.S. Cl. 345/107

(57) ABSTRACT

There is provided a method of driving an electrophoretic display device including electrophoretic elements including electrophoretic particles that is arranged between one pair of substrates, a display unit formed of a plurality of pixels each including a pixel electrode, a pixel switching element, a memory circuit that is connected between the pixel electrode and the pixel switching element, and a switching circuit that is connected between the pixel electrode and the memory circuit, and first and second control lines that are connected to the switching circuit. The method includes extracting a length of the boundary between pixel data of a first gray scale level and pixel data of a second gray scale level from image data transmitted to the display unit as a characteristic amount, determining whether an operation mode of an image displaying operation is to be switched based on the characteristic amount, and switching the operation mode based on the result of the determination acquired in the determining on whether an operation mode is to be switched.

### BACKGROUND

1. Technical Field

The present invention relates to a method of driving an electrophoretic display device, an electrophoretic display device, and an electronic apparatus.

2. Related Art

As electrophoretic display devices of an active matrix type, devices having a switching transistor and a memory circuit in each pixel have been known (see JP-A-2003-84314). In the display device disclosed in JP-A-2003-84314, microcapsules in which charged particles are built are bonded to a substrate in which a switching transistor and a pixel electrode are formed. Then, in the display device, an image is displayed by controlling the charged particles using an electric field that is generated between pixel electrodes and a common electrode that pinch the microcapsules.

However, when displays of different gray scale levels are represented in adjacent pixels of the electrophoretic display device having the memory circuit in each pixel, a large electric potential difference is generated between the adjacent pixel electrodes, and accordingly, there is a problem that a leak current is generated between the pixels.

Here, FIG. 19 is a diagram for describing a leak current between the pixels. FIG. 19 shows two adjacent pixels 140A and 140B that are disposed in a display area of the electrophoretic display device. The pixels 140A and 140B have constituent elements that are common to pixels 40 to be described with reference to FIG. 2 in the latter embodiment.

In addition, scripts “a” and “b” are attached to the constituent elements so as to clearly distinguish adjacent pixels and constituent elements thereof and do not have any other meaning.

the pixel 140A (140B), a driving TFT 41a (41b), a latch circuit 70a (70b), and a pixel electrode 35a (35b) are disposed. The latch circuit 70a (70b) is an SRAM (Static Random Access Memory) type latch circuit. On the pixel electrodes 35a and 35b that are connected to the latch circuits 70a and 70b, electrophoretic elements 32 are disposed through an adhesive agent layer 33. In addition, on the electrophoretic elements 32, a common electrode 37 is formed. Each constituent element inside the pixel will be described in detail in the latter embodiment.

To the pixel electrode 35a of the pixel 140A, a high-level electric potential (high electric potential; for example 15 V) is supplied from a high-electric potential power supply line 50 through a P-MOS transistor 71a of the latch circuit 70a. On the other hand, to the pixel electrode 35b of the pixel 140B, a low-level electric potential (low electric potential; for example 0 V) is supplied from a low-electric potential power supply line 49 through an N-MOS transistor 72b of the latch circuit 70b. In such a case, a leak current through an adhesive agent layer 33 that bonds the pixel electrodes 35a and 35b to the electrophoretic elements 32 is generated due to a horizontal electric field generated by an electric potential difference between the adjacent pixel electrodes 35a and 35b. In the figure, an arrow denoted by a reference sign LP is a leak path.

The leak current is small near one pixel. However, the leak current is generated from all adjacent pixels having different gray scale levels to be displayed, and accordingly, the leak current becomes large in the entire display area. Thereby, there is a problem that the power consumption increases. In particular, when a fine image including a fine photograph or a fine shape is displayed, a ratio of adjacent pixels having different gray scale levels increases. Accordingly, there is a problem that the leak current markedly increases.

### SUMMARY

An advantage of some aspects of the invention is that it provides an electrophoretic display device and a method of driving the electrophoretic display device capable of performing image display with the leak current between pixels suppressed and suppressing the power consumption.

According to a first aspect of the invention, there is provided a method of driving an electrophoretic display device including: a display unit formed of a plurality of pixels each including a pixel electrode, a pixel switching element, a memory circuit that is connected between the pixel electrode and the pixel switching element, and a switching circuit that is connected between the pixel electrode and the memory circuit by pinching electrophoretic elements including electrophoretic particles between one pair of substrates and first and second control lines that are connected to the switching circuit. The method includes: extracting a length of the boundary between pixel data of a first gray scale level and pixel data of a second gray scale level from image data transmitted to the display unit as a characteristic amount; determining whether an operation mode of an image displaying operation is to be switched based on the characteristic amount; and switching the operation mode based on the result of the determination acquired in the determining on whether an operation mode is to be switched.

According to the above-described driving method, before the image data is transmitted to the display unit, the characteristic amount is acquired and evaluated from the image data. Accordingly, the amount of the leak current can be estimated before an image is displayed. In addition, the operation mode relating to the image display can be selected based on the estimation. Accordingly, even when display is performed for the image data for which the leak current can be easily generated, generation of the leak current can be suppressed by changing the operation mode. As a result, the image display can be performed with the leak current between the pixels suppressed, and accordingly, the power consumption can be suppressed.

In the above-described method, it is preferable that the switching of the operation mode is switching between an operation mode for displaying an image in the display unit by supplying image displaying electric potentials to both the first and second control lines and an operation mode including inputting an image displaying electric potential to one control line between the first and second control lines and displaying an image of the first gray scale level in the display unit in a state that the other control line is electrically cut off and displaying an image of the second gray scale level in the display unit by interchanging the control line to which the electric potential is supplied and the control line that is electrically cut off.

In such a case, in the latter operation mode in which the image of the first gray scale level and the image of the second gray scale level are displayed, one between the first and second control lines is necessarily in an electrically cut-off state, and accordingly, the path of the leak current due to the electric potential difference between the adjacent pixel electrodes can be blocked. Thus, by switching to the latter operation mode in which the leak current cannot be easily generated based on the estimated amount of the leak current, an increase of the leak current due to the configuration of the image data is suppressed, and thereby the power consumption can be suppressed.

In the above-described method, the switching of the operation mode may be switching between an operation mode in which a first electric potential is input as the high-level electric potential of the first and second control lines and an operation mode in which a second electric potential lower than the first electric potential is input as the high-level electric potential.

In such a case, in the latter operation mode in which the lower second electric potential is input, the electric potential difference between the pixel electrodes can decrease, and accordingly, generation of the leak current can be suppressed. Accordingly, an image can be displayed with the increase of the leak current suppressed based on the estimated amount of the leak current.

In the above-described method, it is preferable that the extracting of a length of the boundary is counting the number of boundaries between the pixel data of the first gray scale level and the pixel data of the second gray scale level of the image data which corresponds to the adjacent pixels of the display unit.

In such a case, a reasonable amount of the leak current can be estimated from the configuration of the image data. Accordingly, image display can be performed by selecting an appropriate operation mode.

In the above-described method, it is preferable that the extracting of a length of the boundary is extracting the characteristic amount that is embedded in the image data in advance from the image data.

In such a case, the characteristic amount is stored in the image data in advance, and accordingly, the input image data is not needed to be analyzed. As a result, the required circuit can be mounted to the electrophoretic display device without increasing the scale of the circuit.

In the above-described method, it is preferable that the determining on whether an operation mode is to be switched is comparing a reference value set in advance and the characteristic amount and determining whether the operation mode is needed to be switched based on the result of the comparison.

In such a case, it can be determined whether the operation mode is needed to be switched more assuredly at a high speed.

According to a second aspect of the invention, there is an electrophoretic display device including: a display unit formed of a plurality of pixels each including a pixel electrode, a pixel switching element, a memory circuit that is connected between the pixel electrode and the pixel switching element, and a switching circuit that is connected between the pixel electrode and the memory circuit by pinching electrophoretic elements including electrophoretic particles between one pair of substrates; and first and second control lines that are connected to the switching circuit. A characteristic amount acquiring section that extracts a length of the boundary between pixel data of a first gray scale level and pixel data of a second gray scale level from image data transmitted to the display unit as a characteristic amount is disposed in a control unit that controls the display unit, and the control unit determines whether an operation mode of an image displaying operation is to be switched based on the characteristic amount and switches the operation mode based on the result of the determination.

According to the above-described electrophoretic display device, the characteristic amount can be acquired from the image data by using the characteristic amount acquiring section disposed in the control unit before the image data is transmitted to the display unit, and the control unit evaluates the characteristic amount. Accordingly, the amount of the leak current can be estimated before an image is displayed. In addition, the operation mode relating to the image display can be selected based on the estimation. Accordingly, even when display is performed for the image data for which the leak current can be easily generated, generation of the leak current can be suppressed by changing the operation mode. As a result, the image display can be performed with the leak current between the pixels suppressed, and accordingly, the power consumption can be suppressed.

In the above-described electrophoretic display device, it is preferable that the control unit has an operation mode for displaying an image in the display unit by supplying image displaying electric potentials to both the first and second control lines and an operation mode including an operation for supplying an image displaying electric potential to one control line between the first and second control lines and displaying an image of the first gray scale level in the display unit in a state that the other control line is electrically cut off and an operation for displaying an image of the second gray scale level in the display unit by interchanging the control line to which the electric potential is supplied and the control line that is electrically cut off which are switchable therebetween.

In such a case, in the latter operation mode in which the image of the first gray scale level and the image of the second gray scale level are displayed by operations, one between the first and second control lines is necessarily in an electrically cut-off state during the display operation, and accordingly, the path of the leak current due to the electric potential difference between the adjacent pixel electrodes can be blocked. Thus, by switching to the latter operation mode in which the leak current cannot be easily generated based on the estimated amount of the leak current, an increase of the leak current due to the configuration of the image data is suppressed, and thereby the power consumption can be suppressed.

In the above-described electrophoretic display device, the control unit may be configured to have an operation mode in which a first electric potential is input as the high-level electric potential of the first and second control lines and an operation mode in which a second electric potential lower than the first electric potential is input as the high-level electric potential which can be switchable therebetween.

In such a case, in the latter operation mode in which the lower second electric potential is input, the electric potential difference between the pixel electrodes can decrease, and accordingly, generation of the leak current can be suppressed. Accordingly, an image can be displayed with the increase of the leak current suppressed based on the estimated amount of the leak current.

In the above-described electrophoretic display device, it is preferable that the control unit compares a reference value set in advance and the input characteristic amount and determines whether the operation mode is needed to be switched based on the result of the comparison.

In such a case, it can be determined whether the operation mode is needed to be switched more assuredly at a high speed. Accordingly, the electrophoretic display device capable of displaying an image in an appropriate operation mode can be provided.

In the above-described electrophoretic display device, it is preferable that the characteristic amount acquiring section acquires the characteristic amount by counting the number of boundaries between the pixel data of the first gray scale level and the pixel data of the second gray scale level of the input image data which corresponds to the adjacent pixels of the display unit.

In such a case, a reasonable amount of the leak current can be estimated from the configuration of the image data. Accordingly, the electrophoretic display device capable of displaying an image by selecting an appropriate operation mode can be provided.

In the above-described electrophoretic display device, it is preferable that the characteristic amount acquiring section extracts the characteristic amount that is embedded in the image data in advance from the input image data.

In such a case, the characteristic amount is stored in the image data in advance, and accordingly, the input image data is not needed to be analyzed. As a result, the electrophoretic display device capable of suppressing the power consumption without increasing the scale of the circuit can be implemented.

According to a third aspect of the invention, there is provided an electronic apparatus including the above-described electrophoretic display device. According to the above-described configuration, the electronic apparatus having a low power-consuming display unit can be provided.

### BRIEF DESCRIPTION OF THE DRAWINGS

The invention will be described with reference to the accompanying drawings, wherein like numbers reference like elements.

FIG. 1 is a schematic diagram of an electrophoretic display device according to a first embodiment of the invention.

FIG. 2 is a circuit diagram of pixels shown in FIG. 1.

FIG. 3 is a partial cross-section view of the electrophoretic display device according to the first embodiment.

FIG. 4 is a schematic cross-section view of a microcapsule 20 according to the first embodiment.

FIGS. 5A and 5B are diagrams showing the operation of an electrophoretic element according to the first embodiment.

FIG. 6 is a block of the electrophoretic display device according to the first embodiment.

FIG. 7 is a flowchart showing a method of driving the electrophoretic display device according to the first embodiment.

FIG. 8 is a diagram showing a method of counting boundaries of pixels having different gray scale levels according to the first embodiment.

FIG. 9 is a diagram showing a method of counting boundaries of pixels having different gray scale levels according to the first embodiment.

FIG. 10 is a diagram showing a method of counting boundaries of pixels having different gray scale levels according to the first embodiment.

FIG. 11 is a diagram showing a timing chart for a normal display mode according to the first embodiment.

FIG. 12 is a diagram showing states of adjacent pixels in a normal display mode according to the first embodiment.

FIG. 13 is a diagram showing a timing chart for a power-save mode according to the first embodiment.

FIGS. 14A and 14B are diagrams states of adjacent pixels in a power-save mode according to the first embodiment.

FIG. 15 is a timing chart for a power-save mode of an electrophoretic display device according to a second embodiment of the invention.

FIG. 16 is a diagram showing a wrist watch as an example of an electronic apparatus according to an embodiment of the invention.

FIG. 17 is a diagram showing an electronic paper apparatus as an example of an electronic apparatus according to an embodiment of the invention.

FIG. 18 is a diagram showing an electronic notebook as an example of an electronic apparatus according to an embodiment of the invention.

FIG. 19 is a diagram for describing a leak current in an electrophoretic display device.

### DESCRIPTION OF EXEMPLARY EMBODIMENTS

Hereinafter, an electrophoretic display device according to embodiments of the invention will be described with reference to the accompanying drawings. In the embodiments, electrophoretic display devices that are driven in an active matrix mode will be described.

Each of the embodiments represents one form of the invention and does not limit the scope of the invention. Thus, the embodiments can be arbitrary changed within the scope of the technical idea of the invention. In addition, in the drawings below, for easy understanding of each configuration, the scales and the numbers of constituent elements of the structure are represented different from the actual scales and numbers thereof.

### First Embodiment

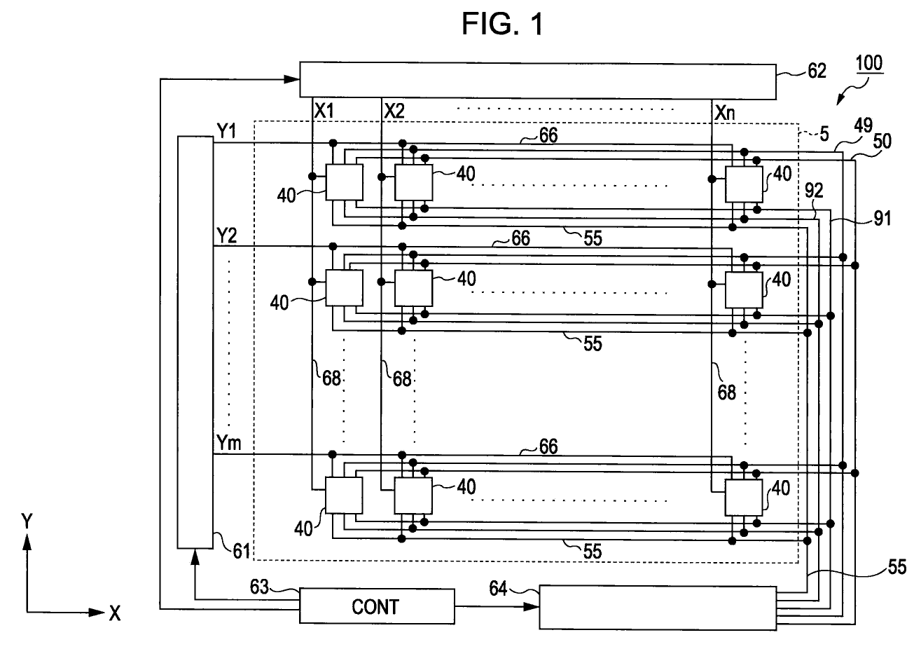

FIG. 1 is a schematic diagram showing the configuration of an electrophoretic display device 100 using an active-matrix driving mode according to a first embodiment of the invention.

The electrophoretic display device 100 includes a display unit 5 in which a plurality of pixels 40 is arranged. In the vicinity of the display unit 5, a scanning line driving circuit 61, a data line driving circuit 62, a controller (control unit) 63, and a common power supply and modulation circuit 64 are disposed. The scanning line driving circuit 61, the data line driving circuit 62, and the common power supply and modulation circuit 64 are connected to the controller 63. The controller 63 comprehensively controls the above-described members based on image data and a synchronization signal that are supplied from an upper-level apparatus.

In the display unit 5, a plurality of scanning lines 66 that is connected from the scanning line driving circuit 61 and a plurality of data lines 68 that extends from the data line driving circuit 62 are formed. In addition, pixels 40 are disposed in correspondence with intersections of the plurality of scanning lines and the plurality of data lines.

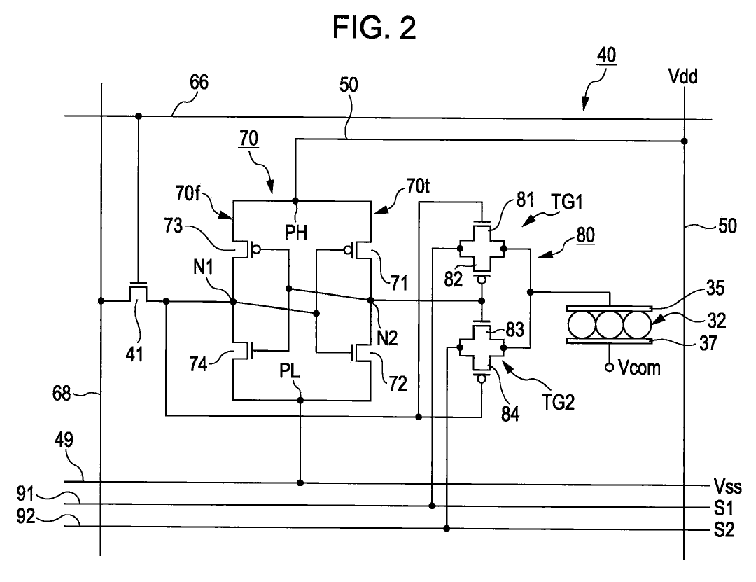

The scanning line driving circuit 61 is connected to the pixels 40 through m scanning lines 66 (Y1, Y2, . . . , Ym). The scanning line driving circuit 61 sequentially selects the scanning lines 66 of the 1st row to the m-th row under control of the controller 63 and supplies a selection signal that defines an ON-timing of a driving TFT 41 (see FIG. 2) disposed in each pixel 40 through the selected scanning line 66.

The data line driving circuit 62 is connected to the pixels 40 through n data lines 68 (X1, X2, . . . , Xn) and supplies an image signal that defines one bit image data corresponding to each pixel 40 to the pixel 40 under control of the controller 63.

In addition, in this embodiment, it is assumed that the data line driving circuit supplies a low-level image signal to the pixel 40 in a case where corresponding image data (pixel data) is defined as “0” and supplies a high-level image signal to the pixel 40 in a case where corresponding image data (pixel data) is defined as “1”.

In the display unit 5, a low-electric potential power supply line 49, a high-electric potential power supply line 50, a common electrode wiring 55, a first control line 91, and a second control line 92 that extend from the common power supply and modulation circuit 64 are disposed, and each wiring is connected to the pixels 40. The common power supply and modulation circuit 64 generates various signals to be supplied to the above-described wirings and electrically connects or disconnects (high impedance state) the wirings, under control of the controller 63.

FIG. 2 is a circuit diagram of the pixels 40.

In the pixel 40, as shown in FIG. 2, a driving TFT (Thin Film Transistor) 41 (pixel switching element), a latch circuit (memory circuit) 70, a switching circuit 80, an electrophoretic element 32, a pixel electrode 35, and a common electrode 37 are disposed. The scanning line 66, the data line 68, the low-electric potential power supply line 49, the high-electric potential power supply line 50, the first control line 91, and the second control lint 92 are disposed so as to surround the above-described elements. The configuration of the pixel 40 is an SRAM (Static Random Access Memory) type in which an image signal is maintained as an electric potential by the latch circuit 70.

The driving TFT 41 is a pixel switching element formed of an N-MOS (Negative Metal Oxide Semiconductor) transistor. The gate terminal of the driving TFT 41 is connected to the scanning line 66, the source terminal of the driving circuit is connected to the data line 68, and the drain terminal of the driving TFT is connected to a data input terminal N1 of the latch circuit 70. The switching circuit 80 is connected to a data output terminal N2 and a data input terminal N1 of the latch circuit 70 and the pixel electrode 35. In addition, between the pixel electrode 35 and the common electrode 37, the electrophoretic element 32 is pinched.

The latch circuit 70 includes a transfer inverter 70t and a feedback inverter 70f. Both the transfer inverter 70t and the feedback inverter 70f are C-MOS inverters. The transfer inverter 70t and the feedback inverter 70f form a loop structure in which, to each input terminal of one between the transfer inverter and the feedback inverter, an output terminal of the other is connected. In addition, to each inverter, a power supply voltage is supplied from the high-electric potential power supply line 50 that is connected through a high-potential power supply terminal PH and the low-electric potential power supply line 49 that is connected through a low-electric potential power supply terminal PL.

The transfer inverter 70t includes a P-MOS transistor 71 and an N-MOS transistor 72 having drain terminals connected to the data output terminal N2. The source terminal of the P-MOS transistor 71 is connected to the high-electric potential power supply terminal PH, and the source terminal of the N-MOS transistor 72 is connected to the low-electric potential power supply terminal PL. The gate terminals (the input terminal of the transfer inverter 70t) of the P-MOS transistor 71 and the N-MOS transistor 72 are connected to the data input terminal N1 (the output terminal of the feedback inverter 70f).

The feedback inverter 70f includes a P-MOS transistor 73 and an N-MOS transistor 74 of which drain terminals are connected to the data input terminal N1. The gate terminals (the input terminal of the feedback inverter 70f) of the P-MOS transistor 73 and the N-MOS transistor 74 are connected to the data output terminal N2 (the output terminal of the transfer inverter 70t).

When a pixel data piece of “1” (a high-level image signal) is stored in the latch circuit 70, a low-level signal is output from the data output terminal N2 of the latch circuit 70. On the other hand, when a pixel data piece of “0” (a low-level image signal) is stored in the latch circuit 70, a high-level signal is output from the data output terminal N2.

The switching circuit 80 is configured to include a first transmission gate TG1 and a second transmission gate TG2.

The first transmission gate TG1 is formed of an N-MOS transistor 81 and a P-MOS transistor 82. The source terminals of the N-MOS transistor 81 and the P-MOS transistor 82 are connected to the first control line 91, and the drain terminals of the N-MOS transistor 81 and the P-MOS transistor 82 are connected to the pixel electrode 35. In addition, the gate terminal of the N-MOS transistor 81 is connected to the data input terminal N1 (the drain terminal of the driving TFT 41) of the latch circuit 70, and the gate terminal of the P-MOS transistor 82 is connected to the data output terminal N2 of the latch circuit 70.

The second transmission gate TG2 is formed of an N-MOS transistor 83 and a P-MOS transistor 84. The source terminals of the N-MOS transistor 83 and the P-MOS transistor 84 are connected to the second control line 92, and the drain terminals of the N-MOS transistor 83 and the P-MOS transistor 84 are connected to the pixel electrode 35. In addition, the gate terminal of the N-MOS transistor 83 is connected to the data output terminal N2 of the latch circuit 70, and the gate terminal of the P-MOS transistor 84 is connected to the data input terminal N1 of the latch circuit 70.

Here, when a pixel data piece of “1” (a high-level image signal) is stored in the latch circuit 70 and thus, the low-level signal is output from the data output terminal N2, the first transmission gate TG1 is in the ON-state, and accordingly, an electric potential S1 supplied through the first control line 91 is input to the pixel electrode 35. On the other hand, when a pixel data piece of “0” (a low-level image signal) is stored in the latch circuit 70 and thus, the high-level signal is output from the data output terminal N2, the second transmission gate TG2 is in the ON-state, and an electric potential S2 supplied through second control line 92 is input to the pixel electrode 35.

The pixel electrode 35 is an electrode that applies a voltage to the electrophoretic element 32 that is formed of Al (aluminum) or the like. The common electrode 37 is an electrode that applies a voltage to the electrophoretic element 32 together with the pixel electrode 35 and is a transparent electrode that is formed of MgAg (Magnesium Silver), ITO (Indium Tin Oxide), IZO (Indium Zinc Oxide), or the like. To the common electrode 37, a common electrode electric potential Vcom is supplied through the common electrode wiring 55. The electrophoretic element 32 displays an image by using an electric field that is generated by an electric potential difference between the pixel electrode 35 and the common electrode 37.

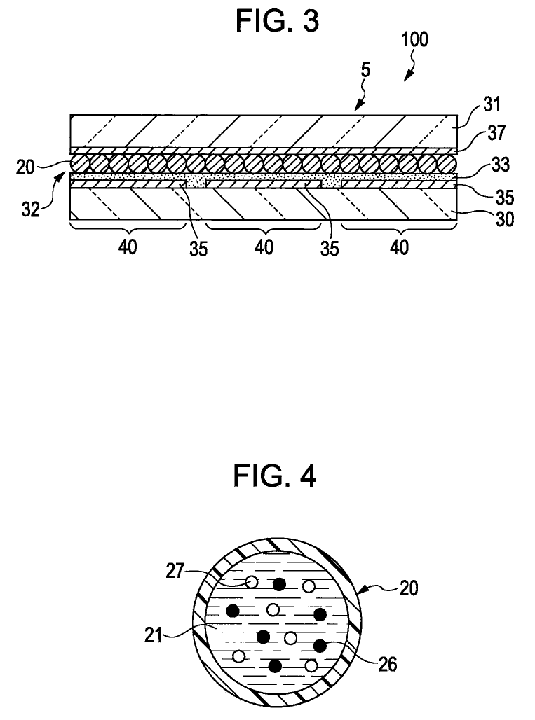

FIG. 3 is a partial cross-section view of the electrophoretic display device 100 showing the display unit 5. The electrophoretic display device 100 has a configuration in which the electrophoretic element 32 formed by arranging a plurality of microcapsules 20 is pinched by the component substrate 30 and the opposing substrate 31. In the display unit 5, on the electrophoretic element 32 side of the component substrate 30, a plurality of the pixel electrodes 35 are arranged, and the electrophoretic element 32 is bonded to the pixel electrodes 35 through an adhesive agent layer 33. In addition, on the electrophoretic element 32 side of the opposing substrate 31, the planar-shaped common electrode 37 that faces a plurality of the pixel electrodes 35 is formed. In addition, on the common electrode 37, the electrophoretic element 32 is disposed.

The component substrate 30 is a substrate that is formed of glass, plastic, or the like. Since the component substrate is disposed on a side opposite to the image display surface, the component substrate may not be transparent. Although not shown in the figure, between the pixel electrode 35 and the component substrate 30, the scanning line 66, the data line 68, the driving TFT 41, the latch circuit 70, and the like that are shown in FIGS. 1 and 2 are formed. On the other hand, the opposing substrate 31 is a substrate that is formed of glass, plastic, or the like. Since the opposing substrate is disposed on the image display side, the opposing substrate is formed as a transparent substrate.

In addition, the electrophoretic element 32 is formed on the opposing substrate 31 side in advance and is generally treated as an electrophoretic sheet including the adhesive agent layer 33. In a manufacturing process, the electrophoretic sheet is handled in a state that a detachable protection sheet is attached to the surface of the adhesive agent layer 33. In addition, by attaching the electrophoretic sheet from which the detachable sheet is taken off to the component substrate 30 (the pixel electrode 35 and various circuits are formed) that is manufactured separately, the display unit 5 is formed. Accordingly, the adhesive agent layer 33 exists only on the pixel electrode 35 side.

FIG. 4 is a schematic cross-section view of the microcapsule 20. The microcapsule 20, for example, has a particle diameter of about 50 μm and is a sphere-shaped body in which a dispersion medium 21, a plurality of white particles (electrophoretic particles) 27, and a plurality of black particles (electrophoretic particles) 26 are enclosed. The microcapsule 20, as shown in FIG. 3, is pinched by the common electrode 37 and the pixel electrode 35, and one or a plurality of microcapsules 20 are disposed within one pixel 40.

The outer shell part (wall film) of the microcapsule 20 is formed of a high molecular resin such as acryl resin including polymethylmethacrylate, polyethylmethacrylate, or the like, urea resin, gum Arabic, or the like.

The dispersion medium 21 is a liquid that disperses the white particles 27 and the black particles 26 into the microcapsule 20. As the dispersion medium 21, water; an alcohol-based solvent such as methanol, ethanol, isopropanol, butanol, octanol, or methyl cellosolve; a variety of esters such as acetic ethyl or acetic butyl; ketone, such as acetone, methylethylketone, or methylisobutylketone; aliphatic hydrocarbon such as pentane, hexane, or octane; cycloaliphatic hydrocarbon such as cyclohexane or methylcyclohexane; aromatic hydrocarbon such as benzene, toluene, or benzene having a long-chain alkyl group including xylene, hexylbenzene, hebuthylbenzene, octylbenzene, nonylbenzene, decylbenzene, undecylbenzenesulfonate, dodecylbenzene, tridecylebenzene, or tetradecylbenzene; halogenated hydrocarbon such as methylene chloride, chloroform, carbon tetrachloride, or 1,2-dichloroethane; carboxylate; or other kinds of oils can be used. The above-described materials may be used in the form of a single material or a mixture. Further, surfactant or the like may be added to the above-described material.

The white particles 27 are particles (polymer particles or colloids) made of white pigment such as titanium dioxide, zinc oxide, or antimony trioxide and, for example, are used in a negatively charged state. The black particles 26 are particles (polymer particles or colloids) made of black pigment such as aniline black or carbon black and, for example, are used in a positively charged state.

In addition, a charge control agent containing particles of an electrolyte, a surfactant, metal soap, a resin, rubber, oil, varnish, compound, or the like; a dispersant such as a titanium-coupling agent, an aluminum-coupling agent, and a silane-coupling agent; a lubricant; a stabilizing agent; or the like may be added to the above-described pigment, as is needed.

Instead of the black particles 26 and the white particles 27, for example, pigment of a red color, a green color, a blue color, or the like may be used. Under such a configuration, the red color, the green color, the blue color, or the like may be displayed in the display unit 5.

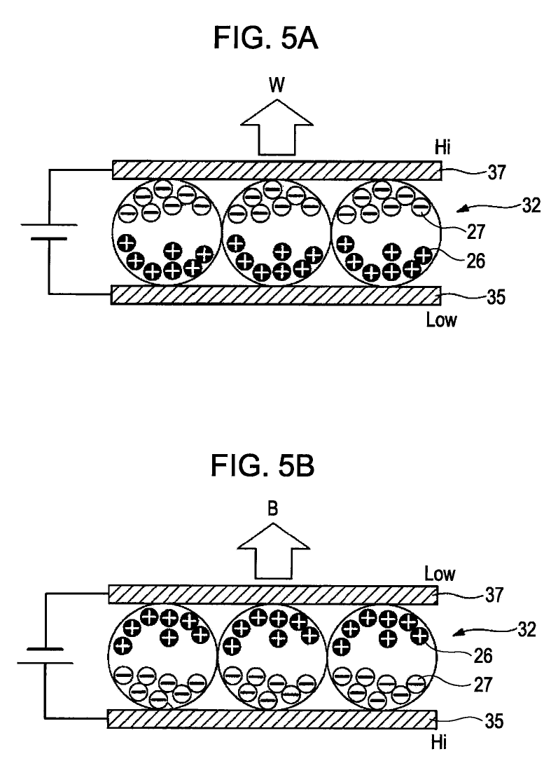

FIGS. 5A and 5B are diagrams showing the operation of the electrophoretic element. FIG. 5A shows a case where the pixel 40 performs a white display, and FIG. 5B shows a case where the pixel 40 performs a black display.

In the case of the white display shown in FIG. 5A, the common electrode 37 is maintained at a relatively high electric potential, and the pixel electrode 35 is maintained at a relatively low electric-potential. Accordingly, the white particles 27 that are negatively charged are attracted to the common electrode 37, and the black particles 26 that are positively charged are attracted to the pixel electrode 35. As a result, when the pixel is viewed from the common electrode 37 side that becomes the display surface side, a white color is recognized.

On the other hand, in the case of the black display shown in FIG. 5B, the common electrode 37 is maintained at a relatively low electric potential, and the pixel electrode 35 is maintained at a relatively high electric-potential. Accordingly, the black particles 26 that are positively charged are attracted to the common electrode 37, and the white particles 27 that are negatively charged are attracted to the pixel electrode 35. As a result, when the pixel is viewed from the common electrode 37 side, a black color is recognized.

In the electrophoretic display device 100, by inputting an image signal to the data input terminal N1 of the latch circuit 70 through the driving TFT 41, the image signal is stored in the latch circuit 70 as an electric potential. Then, by the switching circuit 80 that is operated based on the electric potential output from the data output terminal N2 of the latch circuit 70, the first control line 91 or the second control line 92 and the pixel electrode 35 are connected together. Accordingly, an electric potential corresponding to the image signal is input to the pixel electrode 35, and as shown in FIG. 5, the black display or the white display is represented in the pixel 40 based on the electric potential difference between the pixel electrode 35 and the common electrode 37.

### Control Unit

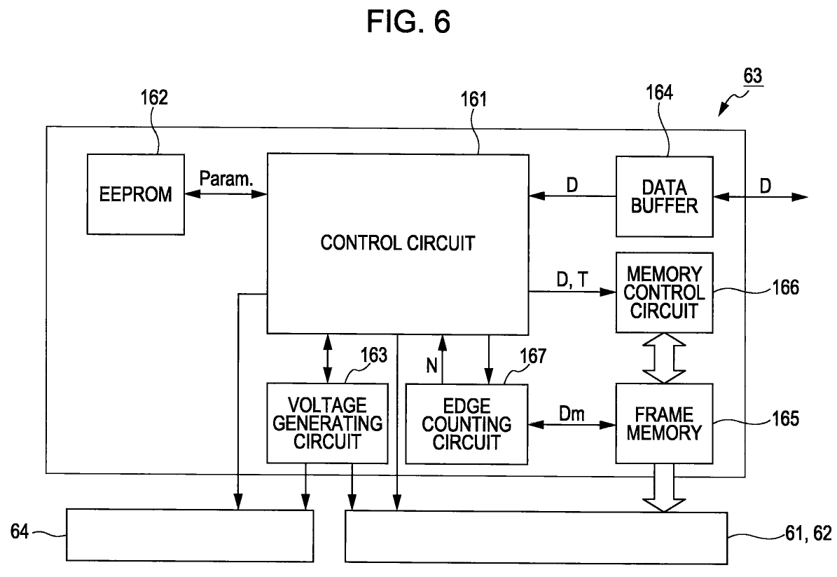

FIG. 6 is a block diagram showing the controller 63 in detail that is disposed in the electrophoretic display device 100.

The controller 63 includes a control circuit 161 as a CPU (Central Processing Unit), an EEPROM (Electrically-Erasable and Programmable Read-Only Memory; memory unit) 162, a voltage generating circuit 163, a data buffer 164, a frame memory 165, a memory control circuit 166, and an edge counting circuit (characteristic amount acquiring unit) 167.

The control circuit 161 generates control signals (timing pulses) such as a clock signal CLK, a horizontal synchronization signal Hsync, and a vertical synchronization signal Vsync and supplies the control signals to each circuit disposed in the vicinity of the control circuit 161.

The EEPROM 162 stores set values (mode setting values and volume values) that are needed for control of operations of each circuit performed by using the control circuit 161. For example, a set value of an operation mode of the common power supply modulating circuit 64 and a volume value of a voltage used for image display that is used in accompaniment with switching between operation modes are stored in the EEPROM. In the EEPROM 162, preset image data that is used for displaying the operation state of the electrophoretic display device or the like may be stored.

The voltage generating circuit 163 is a circuit that supplies driving voltages to the scanning line driving circuit 61, the data line driving circuit 62, and the common power supply and modulation circuit 64.

The data buffer 164 is an interface unit of the controller 63 for the upper-level apparatus. The data buffer maintains the image data D that is input from the upper-level apparatus and transmits the image data D to the control circuit 161.

The frame memory 165 has a memory space corresponding to the arrangement of the pixels 40 of the display unit 5 which data can be read from or written in. The memory control circuit 166 expands the image data D that is supplied from the control circuit 161 based on a control signal to be in correspondence with the arrangement of the pixels 5 of the display unit 5 and writes the expanded image data into the frame memory 165. The frame memory 165 sequentially transmits a data group formed of stored image data D to the data line driving circuit 62 as image signals.

The data line driving circuit 62 latches the image signals, which are transmitted from the frame memory 165, by each one line based on a control signal supplied from the control circuit 161. Then, the data line driving circuit supplies the latched image signals to the data lines 68 in synchronization with the sequential selection operations for the scanning lines 66 which is performed by the scanning line driving circuit 61.

The edge counting circuit 167 reads a data group Dm from the frame memory 165 in accordance with a control signal supplied from the control circuit 161 and maintains the data group internally and counts the number of boundaries of data pieces having different gray scale levels by analyzing the data group Dm internally. In particular, in the data group Dm, a plurality of pixel data pieces of “0” and a plurality of pixel data pieces of “1” that constitute the image data D are expanded in the arrangement corresponding to the arrangement of the pixels of the display unit 5. Accordingly, the edge counting circuit counts the number of boundaries in which the pixel data piece of “0” and the pixel data piece of “1” are adjacent to each other in the vertical or horizontal direction (in the row direction or the column direction) within the arrangement of the pixel data. Then, the edge counting circuit transmits the counted number of the boundaries to the control circuit 161 as a characteristic amount N.

The edge counting circuit 167 may be built in the control circuit 161. In such a case, the control circuit 161 may be configured to acquire the characteristic amount N by using the image data D internally maintained in the control circuit 161 and information on the arrangement of pixels of the display unit 5. Alternatively, the edge counting circuit may be configured to acquire the characteristic amount N from a related data group Dm by inputting the data group Dm that is expanded in the frame memory 165 to the control circuit 165.

### Method of Driving

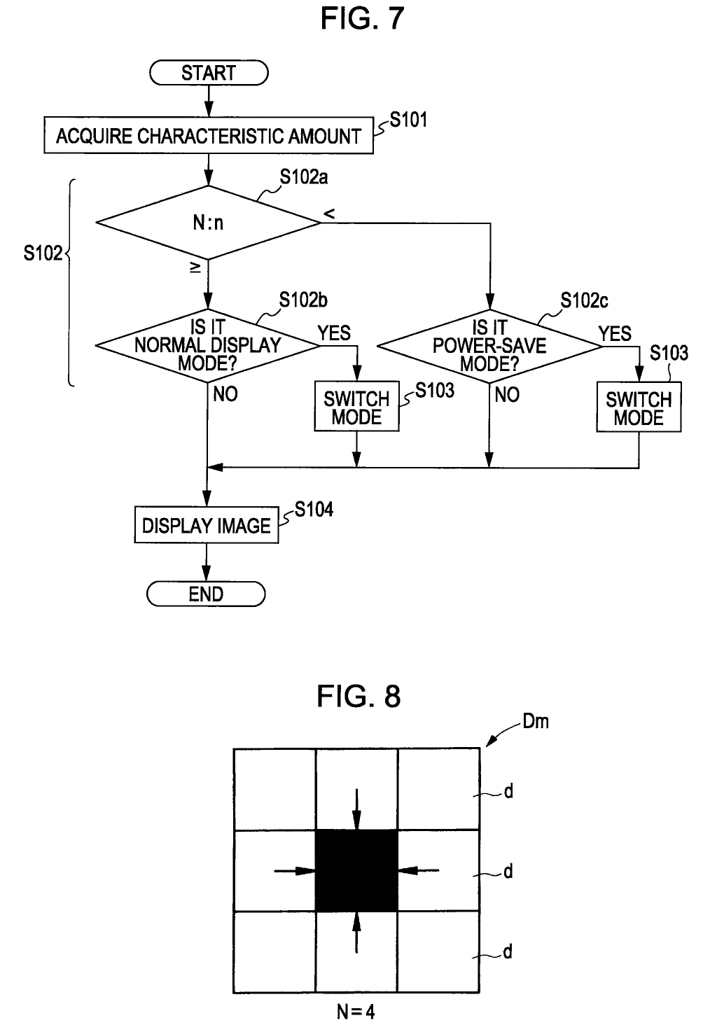

Next, FIG. 7 is a flowchart showing a method of driving the above-described electrophoretic display device. As shown in FIG. 7, the method according to this embodiment includes a characteristic amount acquiring step S101, a characteristic amount determining step S102, a mode switching step S103, and an image displaying step S104.

In addition, in an actual driving process, the image data D of the display image is supplied to the control circuit 161 through the data buffer 164, and the control circuit 161 transmits the supplied image data D to the memory control circuit 166 before the characteristic amount acquiring step S101. Then, the image data D is expanded in the memory space of the frame memory 165 by the memory control circuit 166.

First, in the characteristic amount acquiring Step S101, the edge counting circuit 167 acquires the data group Dm from the frame memory 165 and counts the number of boundaries of gray scale levels included in the data group Dm by analyzing the data group Dm in the circuit. Then, the edge counting circuit 167 transmits the acquired characteristic amount N to the control circuit 161.

Here, FIGS. 8 to 10 are diagrams for describing the method of counting the boundaries of the data group Dm. As shown in FIGS. 8 to 10, the data group Dm has a structure in which pixel data pieces d corresponding to each one pixel are arranged in a matrix shape that is the same as that of the display unit 5. In these diagrams, for the simplification of description, only a part of the data group Dm is extracted and shown.

In the electrophoretic display device 100 according to this embodiment, the pixel 40 to which a low-level image signal corresponding to the pixel data piece of “0” is input represents a white display, and the pixel 40 to which a high-level image signal corresponding to the pixel data piece of “1” is input represents a black display. Accordingly, in FIGS. 8 to 10, the pixel data piece d corresponding to “0” is denoted by a white tile, and the pixel data piece d corresponding to “1” is denoted by a black tile.

First, in the example shown in FIG. 8, a data group Dm is formed of nine pixel data pieces d that are arranged in three rows and three columns. In the data group Dm, one pixel data piece of “1” (black) is disposed in the center, and the pixel data pieces of “0” (white) are disposed in the vicinity thereof. The edges of the tile denoted by arrows shown in the figure are boundaries of data pieces having different gray scale levels. In the data group Dm of this example, the characteristic amount N that is the number of the boundaries denoted by the arrows is four.

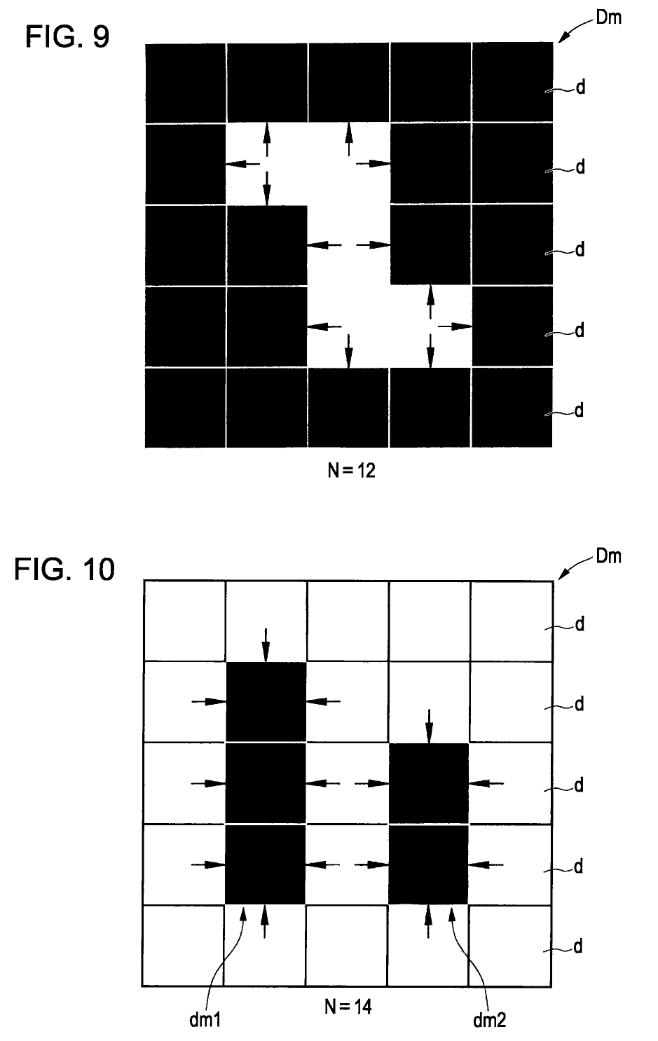

In the example shown in FIG. 9, a data group Dm is formed of 25 pixel data pieces d that are arranged in five rows and five columns. In the data group Dm, five pixel data pieces of “0” (white) that are arranged in a zigzag pattern of an approximate letter S shape are disposed in the center, and the pixel data pieces of “1” (black) are disposed so as to surround the five pixel data pieces of “0”. In this case, the characteristic amount N that is the number of the boundaries is 12.

In addition, in the example shown in FIG. 10, a data group dm1 formed of three pixel data pieces of “1” (black) that are arranged vertically in one column and a pixel data group dm2 formed of two pixel data pieces of “1” (black) that are vertically arranged in one column are disposed so as to be surrounded by the pixel data pieces of “0” (white). In addition, also between the pixel data group dm1 and the pixel data group dm2, the pixel data pieces of “0” (white) are disposed. In this case, the characteristic amount N that is the number of the boundaries is 14.

Although a total number of the pixel data pieces of “1” (black) included in each data group Dm shown in FIGS. 9 and 10 is five, the data group Dm shown in FIG. 10 in which pixel data pieces of “1” (black) are disposed discontinuously has the number of the boundaries larger than that of the data group Dm shown in FIG. 9. Accordingly, the characteristic amount N of the data group Dm shown in FIG. 10 is larger than that shown in FIG. 9.

As a specific method of counting the number of boundaries, various methods may be used.

For example, first, the number of boundaries in the row direction is acquired by counting the number of boundaries (the number of sides) between the pixel data pieces d having different gray scale levels within each row of the data group Dm. Next, the number of boundaries in the column direction is acquired by counting the number of boundaries within each column of the data group Dm in the same manner. Then, by summing the acquired numbers of the boundaries in the row direction and the column direction, the characteristic amount N (the number of boundaries) of the data group Dm can be acquired.

Alternatively, the number of boundaries corresponding to each pixel data piece d may be acquired by comparing the pixel data piece d constituting the data group Dm and gray scale levels of two to four pixel data pieces d having sides adjacent to the pixel data piece d. In such a case, the characteristic amount N can be acquired by summing the numbers of boundaries for all the pixel data pieces d and multiplying the sum by ½.

Although a case where the characteristic amount N is acquired by analyzing the data group Dm that is read from the frame memory 165 has been described, however, a configuration in which the edge counting circuit 167 directly analyzes the image data D may be used.

In such a case, for example, a configuration in which the characteristic amount N is acquired by supplying the image data D for one screen and the information on the arrangement of pixels of the display unit 5 from the control circuit 161 to the edge counting circuit 167 and analyzing the image data D based on the information on the arrangement of pixels by using the edge counting circuit 167 may be used.

When the characteristic amount N is input from the edge counting circuit 167 to the control circuit 161, the process proceeds to the characteristic amount determining step S102. The characteristic amount determining step S102, as shown in FIG. 7, includes a characteristic amount comparing step S102a in which the acquired characteristic amount N and a reference value n for the characteristic amount set in advance is compared and a display mode determining steps S102b and S102c, one of which is selectively performed based on the result of comparison performed in the characteristic amount comparing step S102a.

In the characteristic amount comparing step S102a, the control circuit 161 compares the reference value n for the characteristic amount and the value of the characteristic amount N. A configuration in which the reference value n is stored in the control circuit 161 in advance or the control circuit 161 reads out the reference value n stored in the EEPROM 162 as is needed may be used. In such a case, the reference value n may be configured to be readable from and writable into the EEPROM 162. The reference value n can be appropriately set in accordance with the allowed range of power consumption of the electrophoretic display device 100.

The characteristic amount N and the leak current (power consumption) have a close correlation regardless of the panel size or the number of pixels. The reason is that a leak current is generated between pixels 40 due to electric potential differences of two pixel electrodes 35 that are disposed to be adjacent to each other and all the boundaries between the pixel electrodes 35 having different electric potentials become paths for a leak between pixels. Accordingly, the number of leak paths included in the display unit 5 can be acquired from the characteristic amount N that is the number of the boundaries of pixel data pieces having different gray scale levels, and thus, the amount of the leak current can be estimated based thereon.

When the characteristic amount N is determined equal to or larger than the reference value n from the result of the comparison acquired in the characteristic amount comparing step S102a, the process proceeds to the display mode determining step S102b. In the display mode determining step S102b, it is determined whether the current operation mode is a normal operation mode (normal display mode).

As the result of determination, when the current operation mode is determined to be the normal display mode, the process proceeds to the mode switching step S103. Then, a mode switching operation from the normal display mode to the power-save mode is performed. On the other hand, when the power-save mode is determined as the result of determination, the process proceeds to the image displaying step S104 with the operation mode maintained.

On the other hand, when the characteristic amount N is smaller than the reference value n as the result of comparison performed in the characteristic amount comparing step S102a, the process proceeds to the display mode determining step S102c. In the display mode determining step S102c, it is determined whether the current operation mode is the power-save mode. When the power-save display mode is determined as the result of the determination, the process proceeds to the mode switching step S103, and a mode switching operation from the power-save mode to the normal display mode is performed. On the other hand, when the normal display mode is determined as the result of the determination, the process proceeds to the image displaying step S104 with the operation mode maintained.

In the image displaying step S104, the scanning line driving circuit 61, the data line driving circuit 62, and the common power supply and modulation circuit 64 are driven in accordance with the operation mode determined in the characteristic amount determining step S102 and the mode switching step S103, and thereby an image is displayed in the display unit 5.

Here, the normal display mode and the power-save mode will be described in detail.

### Normal Display Mode

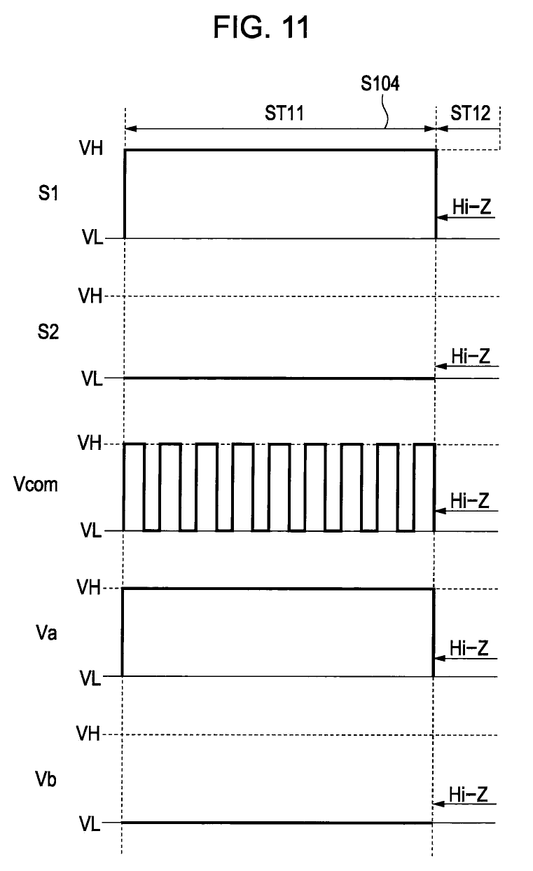

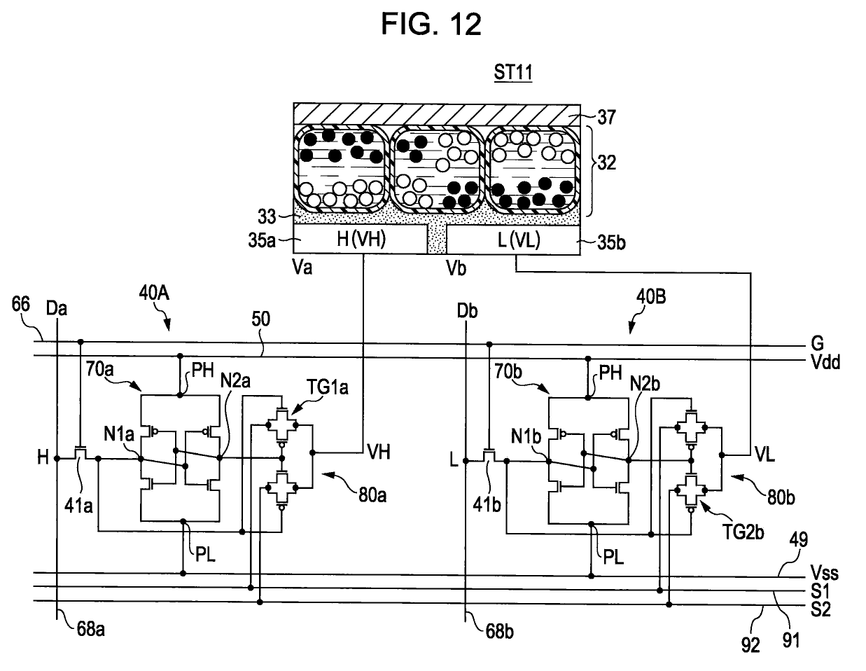

FIG. 11 is a diagram showing a timing chart for the normal display mode. FIG. 12 is a diagram showing electric potential relationship between the pixels 40A and 40B in an image display period ST11 shown in FIG. 11.

In FIGS. 11 and 12, scripts of reference signs “A”, “B”, “a”, and “b” are attached so as to clearly distinguish two pixels 40 to be described and constituent elements thereof and do not have any other meaning.

In FIG. 11, the electric potential S1 of the first control lint 91, the electric potential S2 of the second control line 92, the electric potential Va of the pixel electrode 35a, the electric potential Vb of the pixel electrode 35b, and the electric potential Vcom of the common electrode 37 are shown.

The image displaying step S104 includes a first step in which an image signal is input to the latch circuit 70 through the driving TFT 41 and a second step in which image display is performed by selectively connecting the first control line 91 or the second control line 92 to the pixel electrode 35 by using the switching circuit 80 so as to input an electric potential by operating the switching circuit 80 based on the output of the latch circuit 70 with the image signal maintained.

FIG. 11 shows an image display period ST11 corresponding to the second step of the above-described driving method and a power-off period ST12 thereafter.

In the driving method, prior to the image display period ST11, image signals are input to the latch circuits 70 (70a and 70b) of the pixels 40 (40A and 40B) (the first step).

As shown in FIG. 12, in the pixel 40A representing the black display, a high level H is input to the latch circuit 70a from the data line 68a through the driving TFT 41a. On the other hand, in the pixel 40B representing the white display, a low level L is input to the latch circuit 70b from the data line 68b through the driving TFT 41b.

When the image signals are input to the latch circuits 70a and 70b, the electric potential Vdd of the high-electric potential power supply line 50 is set to be the high level (VH) of image display, and the electric potential Vss of the low-electric potential power supply line 49 is set to be the low level (VL). Accordingly, the electric potential of the data input terminal N1a of the pixel 40A becomes the high level (VH; Vdd), and the electric potential of the data output terminal N2a becomes the low level (VL; Vss). In addition, the electric potential of the data input terminal N1b of the pixel 40B becomes the low level (VL; Vss), and the electric potential of the data output terminal N2b becomes the high level (VH; Vdd).

After inputting the image signals to the latch circuits 70a and 70b of the pixels 40A and 40B as described above, the process proceeds to the image display period ST11 (the second step).

Next, when the process proceeds to the image display period ST11, as shown in FIGS. 11 and 12, the high-level electric potential (VH) is supplied to the first control line 91, and the low-level electric potential (VL) is supplied to the second control line 92.

In the pixel 40A to which the high-level (H) image signal is input, the electric potential of the data input terminal N1a becomes the high level (VH; Vdd), and the electric potential of the data output terminal N2a becomes the low level (VL; Vss). Accordingly, the transmission gate TG1a of the switching circuit 80a is in the ON-state, and thus, the high-level electric potential VH is input to the pixel electrode 35a from the first control line 91.

In the pixel 40B to which the low-level (L) image signal is input, the electric potential of the data input terminal N1b becomes the low level (VL), and the electric potential of the data output terminal N2b becomes the high level (VH). Accordingly, the transmission gate TG2b of the switching circuit 80b is in the ON-state, and thus, the low-level electric potential VL is input to the pixel electrode 35b from the second control line 92.

In addition, to the common electrode 37, a signal in the shape of a pulse in which a high-level (VH) period and a low-level (VL) period are periodically repeated is input.

Then, in the period in which the common electrode 37 is the low level (VL), as shown in FIG. 5B, due to the electric potential difference between the pixel electrode 35a and the common electrode 37, positively charged black particles 26 are attracted to the common electrode 37 side, and the negatively charged white particles 27 are attracted to the pixel electrode 35a. Accordingly, the pixel 40A represents a black display. In addition, in the period in which the common electrode 37 is the high level (VH), as shown in FIG. 5A, due to the electric potential difference between the pixel electrode 35b and the common electrode 37, negatively charged white particles 27 are attracted to the common electrode 37 side, and the positively charged black particles 26 are attracted to the pixel electrode 35a side. Accordingly, the pixel 40B represents a white display.

When the process proceeds to a power-off period ST12 after the image display period ST11, the first and second control lines 91 and 92 and the common electrode 37 are electrically cut off from each other by the common power supply and modulation circuit 64 to be in a high-impedance state. Accordingly, the pixel electrodes 35a and 35b that are connected to any one between the first and second control lines 91 and 92 are in a high-impedance state, too. Accordingly, in the power-off period ST12, the electrophoretic element 32 is in an electrically isolated state to be able to maintain the image without consuming the power.

In the driving method according to this embodiment, in the image display period ST11, a signal in the shape of a pulse in which the high level (VH) and the low level (VL) are periodically repeated is input to the common electrode 37 for a plurality of periods. The above-described driving method is referred to as a “common mode driving method” in descriptions here. A definition for the common mode driving method is a driving method in which a pulse in which the high-level (VH) and the low-level (VL) are repeated is applied to the common electrode 37 over at least one period in the image display period ST11.

According to the common mode driving method, the black particles and the white particles can be moved to desired electrodes more assuredly, and therefore the contrast can be improved. In addition, the electric potentials applied to the pixel electrode and the common electrode can be controlled by using two values of the high level (VH) and the low level (VL), and accordingly, a decrease in the voltage value can be implemented. In addition, the circuit configuration can be simplified. In addition, when the TFT is used as the switching element of the pixel electrode 35, there is an advantage that the reliability of the TFT can be acquired due to low-voltage driving.

It is preferable that the frequency and the number of periods of the common mode driving operation are appropriately set in accordance with the specifications and characteristics of the electrophoretic element 32.

### Power-Save Mode

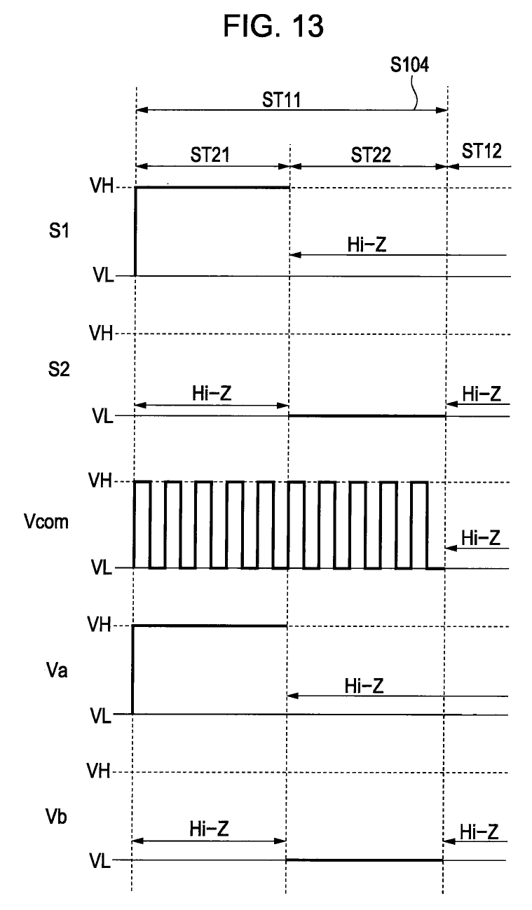

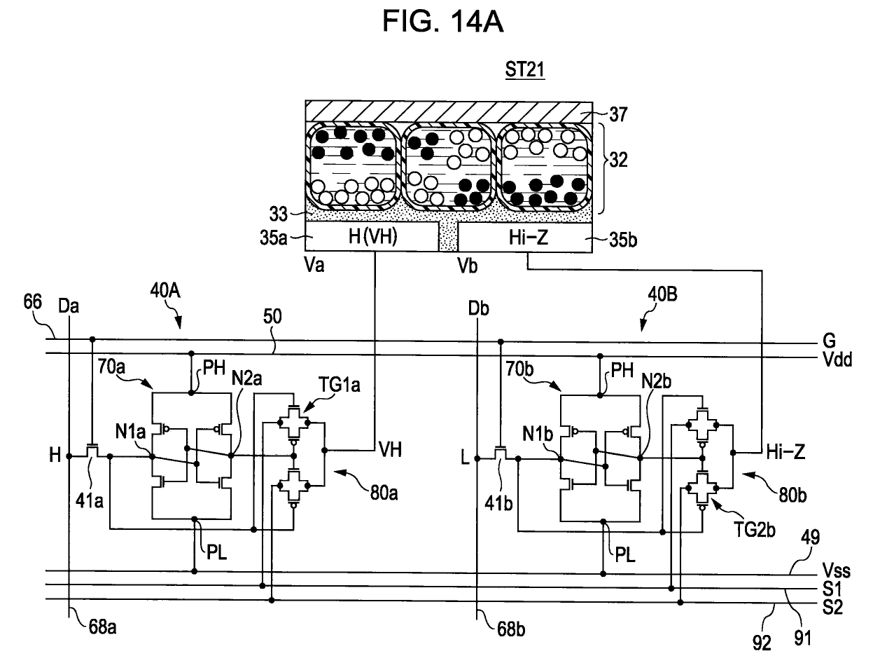

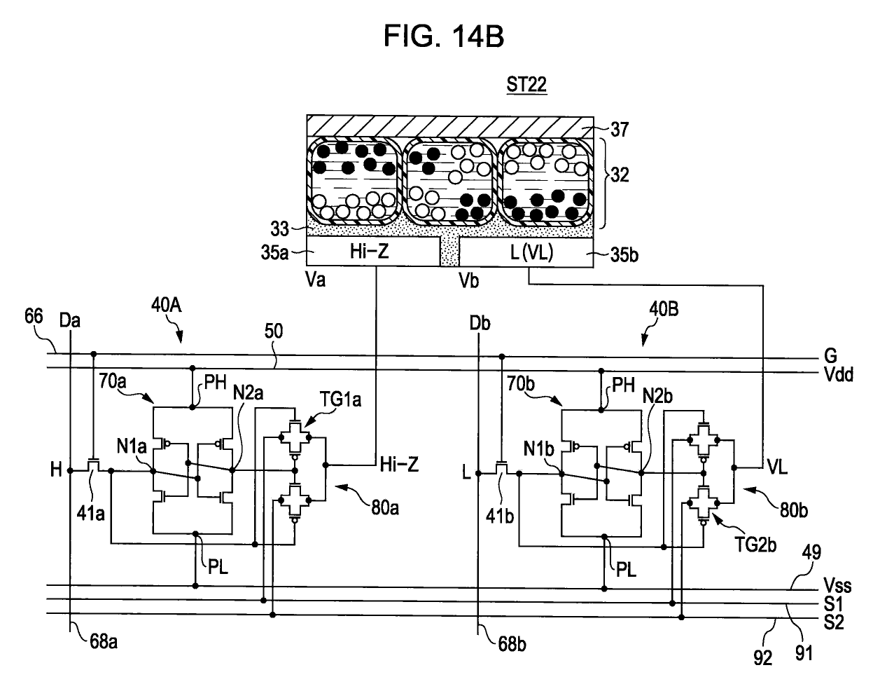

Next, FIG. 13 is a diagram showing a timing chart for the power-save mode. FIG. 14A is a diagram showing electric potential relationship between the pixels 40A and 40B in the black image display period ST21 shown in FIG. 13. FIG. 14B is a diagram showing electric potential relationship between the pixels 40A and 40B in the white image display period ST22. FIGS. 13 and 14 are diagrams corresponding to FIGS. 11 and 12, and to each constituent element that is common to that shown in FIGS. 11 or 12, a same reference sign is assigned.

An image displaying step S104 of the power-save mode, similar to that of the normal display mode, includes a first step in which an image signal is input to a latch circuit 70 and a second step in which image display is performed by inputting an electric potential to a pixel electrode 35 through a switching circuit 80. Since the first step is the same as that of the normal display mode, a description thereof is omitted here. FIG. 13 shows an image display period ST11 that is in the second step and a power-off period ST12 thereafter.

As shown in FIG. 13, the image display period ST11 of the power-save mode includes a black image display period ST21 and a white image display period ST22. These periods may be configured in the opposite order.

Here, Table 1 represents the electric potentials of wirings and electrodes in the image display period ST11. In Table 1, an image signal Da that is input to the pixel 40A, an image signal Db that is input to the pixel 40B, the electric potential Va of the pixel electrode 35a, the electric potential Vb of the pixel electrode 35b, the electric potential S1 of the first control line 91, and the electric potential S2 of the second control line 92 are shown.

TABLE 1

| | |
|---|---|
| ST21 | ST22 |

| | 40A | 40B | 40A | 40B |
|---|---|---|---|---|
| Da | H | — | H | — |
| Db | — | L | — | L |

| | | |
|---|---|---|
| S1 | H(VH) | Hi-Z |
| S2 | Hi-Z | L(VL) |

| | | | | |
|---|---|---|---|---|
| Va | H(VH) | — | Hi-Z | — |
| Vb | — | Hi-Z | — | L(VL) |

First, in the black image display period ST21, as shown in FIGS. 13 and 14A, the high-level electric potential VH is supplied to the first control line 91, and the second control line 92 is in the high impedance state that is electrically cut off.

In the pixel 40A to which the high-level (H) image signal is input, the transmission gate TG1a of the switching circuit 80a is in the ON-state based on the output of the latch circuit 70a, and the high-level electric potential VH is input from the first control line 91 to the pixel electrode 35a. In addition, to the common electrode 37, a signal in the shape of a pulse in which a high-level (VH) period and a low-level (VL) period are periodically repeated is input. Then, in the period in which the common electrode 37 is the low level (VL), a black display is represented in the pixel 40A due to an electric potential difference between the pixel electrode 35a and the common electrode 37.

On the other hand, in the pixel 40B to which the low-level (L) image signal is input, the transmission gate TG2b of the switching circuit 80b is in the ON-state based on the output of the latch circuit 70b, and the second control line 92 and the pixel electrode 35b are connected to each other. However, since the second control line 92 is in the high-impedance state (Hi-Z), the pixel electrode 35b is in the high-impedance state, and thereby, the display of the pixel 40B does not change.

Next, when the process proceeds to a white color image display period ST22, as shown in FIGS. 13 and 14B, a low-level electric potential VL is supplied to the second control line 92, and accordingly, the first control line 91 is in the high-impedance state.

In the pixel 40A to which the high-level (H) image signal is input, the first control line 91 and the pixel electrode 35a are connected through the transmission gate TG1a of the switching circuit 80a. Accordingly, the pixel electrode 35a is in the high-impedance state, and thereby the black display implemented in the black image display period ST21 is maintained.

On the other hand, in the pixel 40B to which the low-level (L) image signal is input, the second control line 92 and the pixel electrode 35b are connected through the transmission gate TG2b of the switching circuit 80b. Accordingly, the low-level electric potential VL is input to the pixel electrode 35b.

In addition, to the common electrode 37, the signal in the shape of a pulse in which a high-level (VH) period and a low-level (VL) period are periodically repeated is input. Accordingly, the pixel 40B represents a white display due to an electric potential difference between the pixel electrode 35b and the common electrode 37 in a period in which the common electrode 37 is at the high-level (VH).

Also in the power-save mode, similar to the normal display mode, the process proceeds to a power-off period ST12 after the image display period ST11. Accordingly, each wiring is in the high-impedance state, and thereby the display image is maintained.

In the normal display mode and the power-save mode described above, the amounts of the leak currents that are generated between pixels in a case where the pixels 40 having different gray scale levels are disposed to be adjacent are completely different from each other.

In the normal display mode, as shown in FIG. 12, the first control line 91 and the second control line 92 are simultaneously driven to perform display in the image display period ST11, and accordingly, there are the pixel electrode 35a having the high-level electric potential VH and the pixel electrode 35b having the low-level electric potential VL within the display unit 5. Thus, when the pixels are disposed adjacently, a leak current is generated through the adhesive agent layer 33 due to the horizontal electric field that is formed between the pixel electrodes 35a and 35b.

To the contrary, in the power-save mode, as shown in FIG. 14, the pixel electrode 35b is in the high-impedance state in the black image display period ST21, and the pixel electrode 35a is in the high-impedance state in the white image display period ST22. Accordingly, in any period, a leak path between the pixels is blocked. Therefore, in the power-save mode, a leak current is scarcely generated.

Accordingly, by switching to the power-save mode for a case where image display is performed using image data D for which the leak current can be easily generated (having large characteristic amount N), display of an image can be performed without increasing the power consumption.

In the mode switching operation in the step S103, it may be configured that series of steps for the normal display mode and the power-save mode are stored in the EEPROM 162 and image display sequences are switched by appropriately reading the series of the steps. The difference between the normal display mode and the power-save mode is only in the timings of the input and cutoff of the electric potentials for the first and second control lines 91 and 92. Thus, alternatively, it may be configured that the common power supply and modulation circuit 64 is configured to include sequences corresponding to the operation modes and the operation modes are switched in accordance with input of a mode switching signal from the control circuit 161.

As described above in detail, according to the electrophoretic display device 100 of this embodiment, the normal display mode and the power-save mode described above are configured to be switchable to each other. Accordingly, an image can be displayed while the normal display mode and the power-save mode are switched based on the characteristic amount N of the image data that is a boundary length between different gray scale levels. Thus, whether the image data of a display image can easily generate a leak current can be determined in advance. Accordingly, the image can be displayed in a display mode in which the leak current decreases, and thereby the power consumption can be suppressed.

In this embodiment, a case where the characteristic amount N is acquired by analyzing the image data D (or the data group Dm) input to the controller 63 from an upper-level apparatus has been described. However, the characteristic amount N may be configured to be input from the upper-level apparatus in accompaniment with the image data D. In other words, it may be configured that the characteristic amount N is acquired as intrinsic information of the image data D at a time when the image data D is generated and the characteristic amount is input in a state embedded in the image data D or together with the image data D to the controller 63 as a data signal. When the characteristic amount N is embedded in the image data D, the control circuit 161 or the memory control circuit 166 acquires the characteristic amount N from the image data D. Alternatively, a function for extracting the characteristic amount N from the image data D may be built in the edge counting circuit 167.

When the characteristic amount N is configured to be input from the upper-level apparatus as separate information acquired in advance, the edge counting circuit 167 can be omitted, and accordingly, the circuit scale of the controller 63 can decrease.

In addition, when the preset image data is stored in the EEPROM 162, it is preferable that the characteristic amount N is embedded in the preset image data in advance or the characteristic amount N of the preset image data is stored in the EEPROM 162.

### Second Embodiment

Next, a second embodiment of the invention will be described with reference to the accompanying drawings.

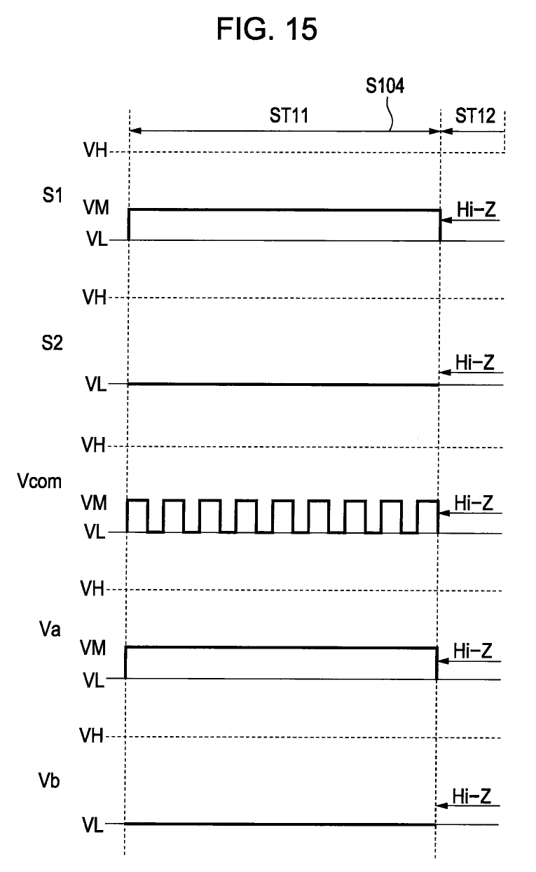

FIG. 15 is a timing chart for a power-save mode of an electrophoretic display device according to this embodiment. FIG. 15 corresponds to FIG. 13 that represents the power-save mode according to the first embodiment. The name and reference sign of each part shown in FIG. 15 is the same as those shown in FIG. 13.

In the first embodiment, a driving method in which the forms of supply of electric potentials to the first control line 91 and the second control line 92 are switched in accordance with the characteristic amount N is used. To the contrary, in this embodiment, a simpler method, and more particularly, a method in which voltages applied to a pixel electrode 35 are switched in accordance with the characteristic amount N is used.

The mechanical configuration of the electrophoretic display device according to this embodiment is the same as that of the electrophoretic display device 100 according to the first embodiment. The difference between the first and second embodiments is that an operation mode of which timing chart is shown in FIG. 15 is included as a power-save mode in the second embodiment. Thus, in descriptions below, the driving method will be mainly described with descriptions common to the first embodiment appropriately omitted.

The operation flow of the driving method according to this embodiment is the same as that according to the first embodiment shown in FIG. 7. In other words, the driving method includes a characteristic amount acquiring step S101, a characteristic amount determining step S102, a mode switching step S103, and an image displaying step S104.

In the characteristic amount determining step S102, the characteristic amount N acquired in the step S101 and a reference value n of the characteristic amount which is set in advance are compared with each other, and it is determined whether the mode is needed to be switched based on the result of comparison and the current operation mode. When switching of the mode is determined to be needed as the result of the determination, the process proceeds to the mode switching step S103, and mode switching between the normal mode and the power-save mode is performed.

In the image displaying step S104, the scanning line driving circuit 61, the data line driving circuit 62, and the common power supply and modulation circuit 64 are driven in accordance with the operation mode determined in the characteristic amount determining step S102 and the mode switching step S103, and thereby an image is displayed in the display unit 5.

In this embodiment, the normal display mode is the same as that in the first embodiment which has been described with reference to FIG. 11. On the other hand, in the power-save mode, the electric potentials of signals supplied to the first control line 91 and the common electrode 37 are lowered from those of the normal display mode shown in FIG. 11. In other words, in the image display period ST11, an intermediate electric potential VM (for example, 5 V) that is lower than the high-level electric potential VH (for example, 15 V) is supplied to the first control line 91. In addition, to the common electrode 37, a rectangular wave in which the intermediate electric potential VM and the low-level electric potential VL are periodically repeated is supplied. As a result, in the power-save mode, the electric potential Va of the pixel electrode 35a that is the high-level electric potential VH in the normal mode becomes the intermediate electric potential VM.

In addition, in the above-described operation, the control circuit 161 of the controller 63 reads a set value (for example, 5 V) corresponding to the intermediate electric potential VM of the power-save mode from the EEPROM 162 and transmits a control signal including the set value and a command to the voltage generating circuit 163. Then, the voltage generating circuit 163 that has received the control signal changes the high-electric potential values of the electric potential S1 supplied to the first control line 91 and the electric potential Vcom supplied to the common electrode 37 based on the received set value.

Accordingly, in the power-save mode, the electric potential of the pixel electrode 35a is the intermediate electric potential VM (for example, 5 V), and the electric potential of the pixel electrode 35b is the low-level electric potential VL (for example, 0 V). Thus, an electric potential difference between the pixel electrodes 35a and 35b becomes smaller than that of the normal display mode. Accordingly, a leak current flowing between the pixel electrodes 35a and 35b through the adhesive agent layer 33 can decrease.

In the above-described second embodiment, by only changing the electric potentials supplied to the first control line 91 and the common electrode 37, the normal display mode and the power-save mode can be switched to each other. Accordingly, it is possible to mount the controller 63 and the common power supply and modulation circuit 64 without complicating the configurations thereof. As a result, the low power consumption of the electrophoretic display device can be implemented without increasing costs for circuits in the vicinity of the controller.

However, in the power-save mode according to this embodiment, the voltage used for driving the electrophoretic display element 32 is decreased, and accordingly, the display contrast is lowered, compared to the power-save mode according to the first embodiment. Thus, it is preferable that this embodiment is employed for use (for example, the use for a mobile device or the like) for which the power consumption precedes the display quality.

In addition, the driving method according to the second embodiment may be employed not only in the electrophoretic display device 100 including the pixel 40 having the switching circuit 80 shown in FIG. 2 but also in the driving method for the electrophoretic display device including pixels 140 (140a and 140b) shown in FIG. 19.

In the electrophoretic display device including the pixel 140a (140b) in which the switching circuit 80 is not included and the pixel electrode 35a (35b) is connected to the latch circuit 70a (70b), the voltage for image display which is applied to the pixel electrode 35a is the electric potential Vdd of the high-level power supply line 50. Thus, when the driving method according to the second embodiment is employed in such an electrophoretic display device, in the power-save mode, the electric potential Vdd of the high-level power supply line 50 is set to be an electric potential (for example, 5 V) that is lower than the high-level electric potential (for example, 15 V) in the normal display mode. In addition, the high-level electric potential side of the electric potential Vcom of the common electrode 37 is set to be lowered in accordance with lowering the electric potential of the pixel electrode 35a (for example, 5 V). Accordingly, the operation that is the same as that of the electrophoretic display device according to this embodiment can be implemented.

In addition, in the driving method according to the second embodiment, the voltage applied to the electrophoretic display device 32 in the power-save mode is lowered than that in the normal display mode. Accordingly, the driving method according to the second embodiment can be applied to an electrophoretic display device that has a configuration in which the common mode driving is not performed in the image displaying step S104 without causing any problem.

### Electronic Apparatus

Next, cases where the electrophoretic display device 100 according to each of the above-described embodiment is applied to an electronic apparatus will be described.

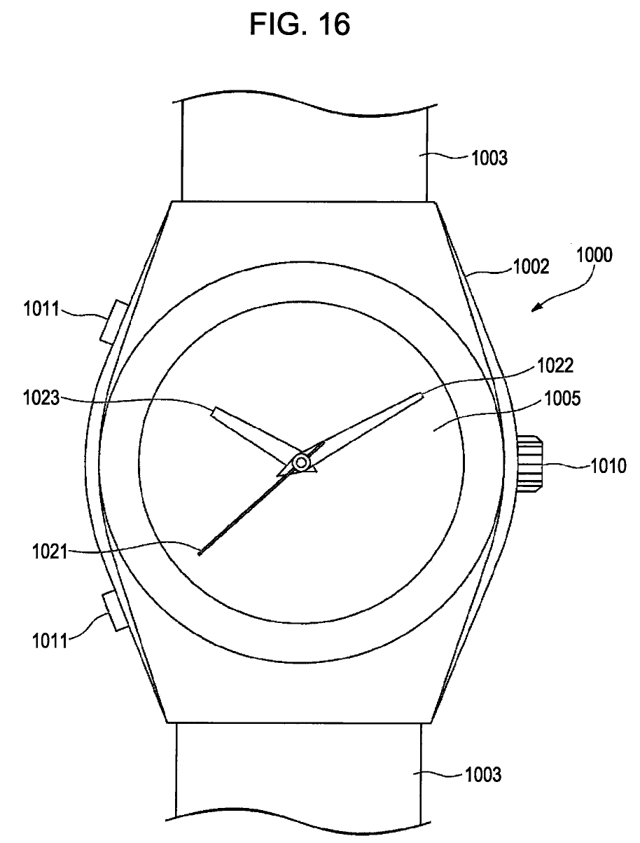

FIG. 16 is a front view of a wrist watch 1000. The wrist watch 1000 includes a watch case 1002 and a pair of bands 1003 connected to the watch case 1002.

In the front side of the watch case 1002, a display unit 1005 that is configured by the electrophoretic display device 100 according to each of the above-described embodiments, a second hand 1021, a minute hand 1022, and an hour hand 1023 are disposed. In addition, on the side of the watch case 1002, a winder 1010 as an operator, and an operation button 1011 are disposed. The winder 1010 is connected to a hand setting stem (not shown) disposed inside the case and is provided such that the winder together with the hand setting stem can be pushed or pulled at multiple levels (for example, two levels) and rotated. In the display unit 1005, an image that becomes the background, a character string such as date, time, or the like, a second hand, a minute hand, an hour hand, and the like can be displayed.

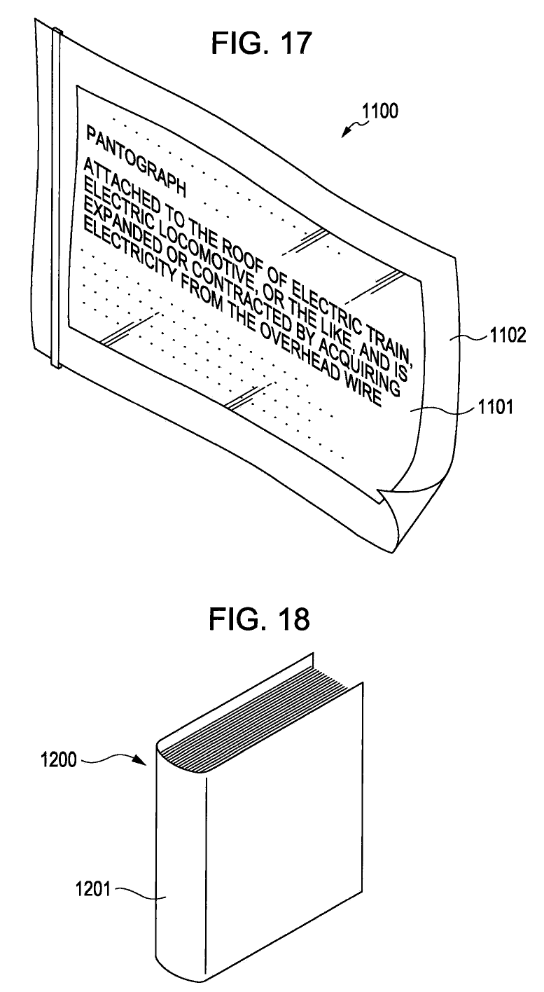

Next, FIG. 17 is a perspective view showing the configuration of an electronic paper apparatus 1100. The electronic paper apparatus 1100 includes the electrophoretic display device 100 according to each of the above-described embodiments in a display area 1101. The electronic paper apparatus 1100 has flexibility and is configured to include a main body 1102 formed of a re-recordable sheet having same texture and flexibility as those of a general paper sheet.

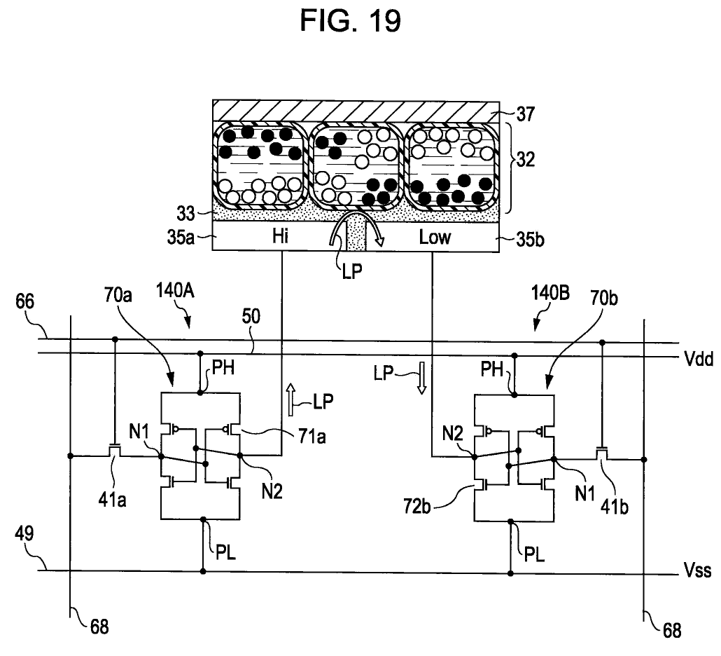

FIG. 18 is a perspective view showing the configuration of an electronic notebook 1200. The electronic notebook 1200 is formed by binding a plurality of the electronic paper apparatuses 1100 shown in FIG. 17 and inserting the electronic paper apparatuses into a cover 1201. The cover 1201 includes a display data inputting unit that receives display data not shown in the figure, for example, transmitted from an external apparatus. Accordingly, the display content of the electronic paper apparatuses can be changed or updated in a state that the electronic paper apparatuses are bound in accordance with the display data.

According to the wrist watch 1000, the electronic paper apparatus 1100, and the electronic notebook 1200, the electrophoretic display device according to an embodiment of the invention is employed in a display unit, and therefore the electronic apparatuses have display units each having a superior power-saving feature.

In addition, the electronic apparatuses shown in FIGS. 16 to 18 are examples of electronic apparatuses according to embodiments of the invention and do not limit the technical scope of the invention. For example, the electrophoretic display device according to an embodiment of the invention can be appropriately used in a display unit of an electronic apparatus such as a cellular phone, a mobile audio apparatus, or the like.

The entire disclosure of Japanese Patent Application No. 2008-013634, filed Jan. 24, 2008 is expressly incorporated by reference herein.

What is claimed is:

1. A method of driving an electrophoretic display device, the electrophoretic display device comprising:
electrophoretic elements including electrophoretic particles that is arranged between one pair of substrates;
a display unit formed of a plurality of pixels each including a pixel electrode, a pixel switching element, a memory circuit that is connected between the pixel electrode and the pixel switching element, and a switching circuit that is connected between the pixel electrode and the memory circuit; and
first and second control lines that are connected to the switching circuit, and
the method comprising:
extracting a length of the boundary between pixel data of a first gray scale level and pixel data of a second gray scale level from image data transmitted to the display unit as a characteristic amount;
determining whether an operation mode of an image displaying operation is to be switched based on the characteristic amount; and
switching the operation mode based on the result of the determination acquired in the determining on whether an operation mode is to be switched.

2. The method according to claim 1, wherein the switching of the operation mode is switching between a first operation mode and a second operation mode, the first operation mode being for displaying an image in the display unit by supplying image displaying electric potentials to both the first and second control lines, the second operation mode being for displaying an image of the first gray scale level in the display unit by inputting an image displaying electric potential to either the first control line or the second control line in a state that the other control line is electrically cut off and displaying an image of the second gray scale level in the display unit by interchanging the control line to which the electric potential is supplied and the control line that is electrically cut off.

3. The method according to claim 1, wherein the switching of the operation mode is switching between an operation mode in which a first electric potential is input as the high-level electric potential of the first and second control lines and an operation mode in which a second electric potential lower than the first electric potential is input as the high-level electric potential.

4. The method according to claim 1, wherein the extracting of a length of the boundary is counting the number of boundaries between the pixel data of the first gray scale level and the pixel data of the second gray scale level of the image data which corresponds to the adjacent pixels of the display unit.

5. The method according to claim 1, wherein the extracting of a length of the boundary is extracting the characteristic amount that is embedded in the image data in advance from the image data.

6. The method according to claim 1, wherein the determining on whether an operation mode is to be switched is comparing a reference value set in advance and the characteristic amount and determining whether the operation mode is needed to be switched based on the result of the comparison.

7. An electrophoretic display device comprising:
electrophoretic elements including electrophoretic particles between one pair of substrates;
a display unit formed of a plurality of pixels each including a pixel electrode, a pixel switching element, a memory circuit that is connected between the pixel electrode and the pixel switching element, and a switching circuit that is connected between the pixel electrode and the memory circuit; and
first and second control lines that are connected to the switching circuit,
wherein a characteristic amount acquiring section that extracts a length of the boundary between pixel data of a first gray scale level and pixel data of a second gray scale level from image data transmitted to the display unit as a characteristic amount is disposed in a control unit that controls the display unit, and
wherein the control unit determines whether an operation mode of an image displaying operation is to be switched based on the characteristic amount and switches the operation mode based on the result of the determination.

8. The electrophoretic display device according to claim 7, wherein the control unit has a first operation mode and a second operation mode, the first operation mode being for displaying an image in the display unit by supplying image displaying electric potentials to both the first and second control lines, the second operation mode including an operation for displaying an image of the first gray scale level in the display unit by supplying an image displaying electric potential to one control line between the first and second control lines in a state that the other control line is electrically cut off and an operation for displaying an image of the second gray scale level in the display unit by interchanging the control line to which the electric potential is supplied and the control line that is electrically cut off which are switchable therebetween.

9. The electrophoretic display device according to claim 7, wherein the control unit has an operation mode in which a first electric potential is input as the high-level electric potential of the first and second control lines and an operation mode in which a second electric potential lower than the first electric potential is input as the high-level electric potential which can be switchable therebetween.

10. The electrophoretic display device according to claim 7, wherein the control unit compares a reference value set in advance and the input characteristic amount and determines whether the operation mode is needed to be switched based on the result of the comparison.

11. The electrophoretic display device according to claim 7, wherein the characteristic amount acquiring section acquires the characteristic amount by counting the number of boundaries between the pixel data of the first gray scale level and the pixel data of the second gray scale level of the input image data which corresponds to the adjacent pixels of the display unit.

12. The electrophoretic display device according to claim 7, wherein the characteristic amount acquiring section extracts the characteristic amount that is embedded in the image data in advance from the input image data.

13. An electronic apparatus comprising the electrophoretic display device according to claim 7.
